(19) United States
(12) Patent Application Publication
(10) Pub. No.: US 2024/0221049 A1
(43) Pub. Date: Jul. 4, 2024

(54) Method and system for creating indoor image datasets using procedural generation and 3D mesh conversion

(71) Applicant: SEOUL NATIONAL UNIVERSITY R&DB FOUDATION, Seoul (KR)

(72) Inventors: Jae Seung LEE, Seoul (KR); Dohyeon KIM, Seoul (KR); Soowoong HWANG, Seoul (KR); Junhyeck CHOI, Seoul (KR)

(21) Appl. No.: 17/921,970

(22) PCT Filed: Mar. 10, 2022
(86) PCT No.: PCT/KR2022/003324

§ 371 Date: Dec. 7, 2022

(30) Foreign Application Priority Data
Mar. 11, 2021 (KR) 10-2021-0032206

(51) Int. Cl. G06Q 30/0601; G06N 3/0475; G06Q 30/0207

(52) U.S. Cl. CPC G06Q 30/0631; G06N 3/0475; G06Q 30/0207; G06Q 30/0643; G06Q 2220/00

(57) ABSTRACT

The present invention provides an interior decoration recommendation service utilizing an algorithm based on artificial intelligence and a blockchain-based platform comprising the service. A multitude of interior decoration styles are recommended according to a range of themes using an algorithm based on generative adversarial networks (GANs). The goods and elements are immediately applied to the generated styles or the current styles of spaces are analyzed, and suitable interior decoration goods are automatically recommended.

### TECHNICAL FIELD

The designed invention presents a method and device of offering recommendation on interior decoration using generative adversarial networks (GANs), which are capable of providing a customized interior decoration service depending on the space atmosphere and user preference in GANs.

### BACKGROUND ART

The development of technology together with an increase in single-person households and the spread of coronavirus disease in 2019 (COVID-19), extending over a considerable period of time, have resulted in increased in-home activities and demand for small-scale remodeling work and self-interior decorations. As a result, stores specializing in large-sized furniture and do-it-yourself (DIY) goods have grown in popularity, and there has been an increasing trend of using online interior decoration platforms, which, in response, have been expanding their services to attract users and start-ups.

Space, which refers here to a house, is no longer considered to be only a place for rest and private affairs. House space has now transformed into a space where one also works. As the amount of time people spend at their homes has increased, the existing concepts of house structures and interior decoration have also been revised.

However, as existing online interior decoration platforms provide only limited services, such as examples of construction work, it has become difficult to satisfy the growing range of customer requirements and choose an appropriate design for the target space. In particular, to change interior decoration, the customer mostly has only one option: to receive the service of limited furnishing from an interior decoration dealer working in the neighborhood. When consulting with the program that large interior decoration companies provide, they face unreasonable complications. For example, when customers visit an affiliated store, they can book a consultation (the first consultation is often paid). Before the consultation, they are expected to measure the dimensions of the target space and schedule a visit to their home with the company. Therefore, the entire process requires considerable time. If a private person carries out construction works for interior decoration themselves, this scheme of work is disadvantageous as it entails a considerable waste of time, money, and property due to the trial-and-error approach and requires various technological or subsidiary materials and tools. Apart from that, there is a probability that the construction work can fail due to the lack of experiences.

Therefore, there is an increasing demand for a function that can coordinate and customize interior decoration using technologies that can promptly change the concept of space and suggest appropriate interior decoration elements.

### DETAILED DESCRIPTION OF THE INVENTION

### Technical Problem

The suggested invention has been devised to solve the aforementioned issues and provide a method and device of offering recommendation on interior decoration which are trained based on the user location and data derived from a prior questionnaire using GANs, or adversarial artificial intelligence networks, and a terminal camera with an embedded time-of-flight (ToF) sensor, providing a customized recommendation service considering the space atmosphere and user preference.

### Solution to the Problem

To solve the aforementioned problem, the method of providing recommendations regarding interior decoration using GANS can comprise the following user steps. First, preference, or requirements, information is received from the user terminal. Second, data are collected by measuring the target space using the user terminal camera. Third, plane views and objects essential to interior decoration are identified in the collected data. Fourth, user preference is analyzed using generative adversarial networks (GANs), and interior decoration designs are generated by themes to arrange each interior decoration element in the spaces, and are provided to the user terminal. Finally, the fifth step is to provide the user terminal with a service environment and offer the user a partner company server that offers goods matching the selected interior decoration elements.

There are several possible variations in the device. In the first step, the user terminal can be provided with a block chain coin when the device of offering recommendations on interior decoration receives user preferences from the user terminal.

The fourth step can analyze user preferences with the help of GANs, create the design of the space, arrange furniture, and provide visualizations of the space. Alternatively, the fourth step can search for applied laws and ordnances by analyzing user preference with the help of GANs and design sample 2D drawings and 3D models, generating interior decoration designs by themes to arrange each interior decoration element in the space.

The fifth step can also produce a blockchain coin provided by a partner company server after user preference is shared with it. After the fifth step is carried out, the user terminal provides a partner company server with the cost of the goods in a block chain coin, and the user terminal registers an afternote and the grade of the goods with a partner company server using a dispersion-type published ledger.

The method can also include a training step. In this case, GANs are trained before the first step and become a conditional generative adversarial network (CGAN) that is trained using a style dataset, in which the interior decoration designs are sorted by themes, and a location dataset, in which interior decoration designs are sorted by location.

The device of offering recommendations on interior decoration using GANs can comprise the following units. A data-receiving unit is configured to receive user preference and the data resulting from measuring the space with the user terminal camera. An interior decoration constitution unit is configured to detect plane views and objects essential to interior decoration based on the data and to analyze user preferences with the help of GANS, generating interior decoration designs by themes to arrange each interior decoration element in the space and provide the user terminal with the options. Finally, a sale environment provision unit is configured to provide the user terminal with a service environment in which a partner company server offers goods matching the selected interior decoration elements.

The device of offering recommendation on interior decoration can also comprise a coin processing unit configured to provide the user terminal with a block chain coin when user preference information is received from the user terminal.

Furthermore, an interior decoration constitution unit can analyze user preferences and then design spaces, arrange furniture, and provide visualizations of the space according to user preferences. This unit can also search applied laws and ordnances by analyzing user preferences with the help of GANs and design sample 2D drawings and 3D models, generating interior decoration designs by themes to arrange each interior decoration element in the space and provide their visualizations.

Additionally, the coin processing unit can receive the blockchain coin from a partner company server after providing them with user preference information.

### Effect of the Invention

As the interior decoration recommendation service and a block chain-based platform use an algorithm based on artificial intelligence, a plurality of interior decoration styles categorized by themes are recommended to the user with the help of a GAN-based algorithm. Thus, goods and elements are immediately selected to match the suggested styles; alternatively, the current style of the space can be analyzed, and interior decoration goods are recommended to suit the existing style. Photographs of the spaces in the desired interior decoration styles are generated by the construction of a real algorithm prototype. In the future, these photographs can be converted into images visualizing the desired styles by securing datasets and improved models, or the desired furniture can be arranged within the photographs through synthesis. The recommendation of new designs rather than the previous recommendation of only existing goods is also presented on the basis of the algorithm. Thus, service goods linked to a smart factory can also be provided.

The invention may provide a customized interior decoration recommendation service, taking into consideration the space atmosphere and user preferences obtained with the help of GANs and the user terminal camera with an embedded ToF sensor. It can also provide an estimate for interior decoration and a blockchain system that examines laws and ordinances using artificial intelligence, evaluates suitability, and offers the brokerage function, facilitating access to ready-made goods and a smart factory, enabling stable and transparent operation.

Finally, the data used in the invention and generated on the basis of user activities are utilized to improve the recommended models. After processing the information, it is used to gather marketing data for customers and is circulated as coins in the system of offering recommendation on interior decoration. Coins can thus be prevented from inflation, inducing a continuous rise in value.

### BRIEF DESCRIPTION OF THE DRAWINGS

FIG. 1: The system of offering recommendation on interior decoration using GANs based on one of the possible realizations.

FIG. 2: A block diagram showing a device of offering recommendation on interior decoration using GANs based on one of the possible realizations.

FIG. 3: A flow chart explaining the method of offering recommendation on interior decoration using GANS based on one of the possible realizations.

FIGS. 4 and 5: Views of the method used to recommend interior decoration using GANs based on one of the possible realizations.

FIGS. 6-14: The GANs used in a possible realization of the invention.

FIGS. 15-26: Training methods and results concerning the method of offering recommendation on interior decoration using GANs based on one of the possible realizations.

FIG. 27: A blockchain used in the method of offering recommendation on interior decoration and the system of offering recommendation on interior decoration based on one of the possible realizations.

FIG. 28: The ToF sensor in one of the possible realizations of the invention.

### MODE TO REALIZE THE INVENTION

In this section, preferable realizations of the invention are described in detail with reference to the accompanying drawings. In the following descriptions, detailed descriptions of the conventional functions or constitutions related to the invention are omitted as they can obscure the gist of the invention. In addition, the corresponding sizes of the constituent elements shown in the drawings can be exaggerated for the sake of description and, therefore, may not reflect the actual applied sizes.

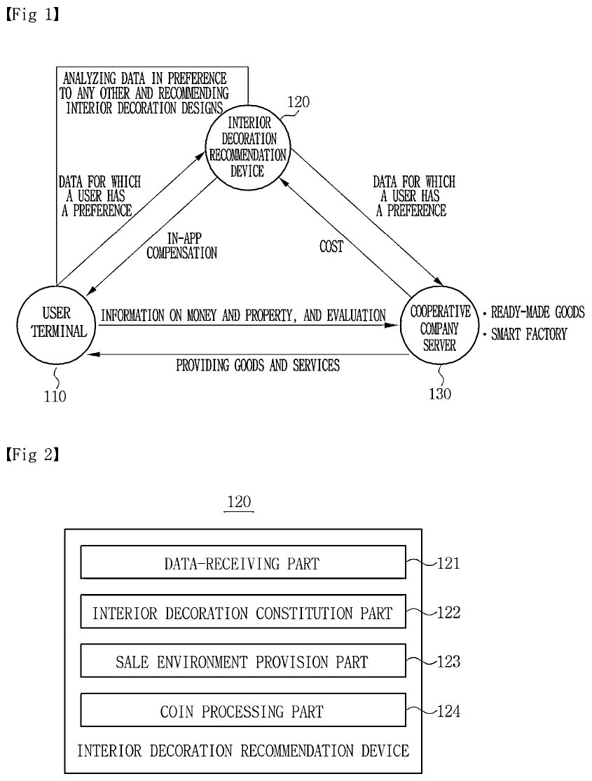

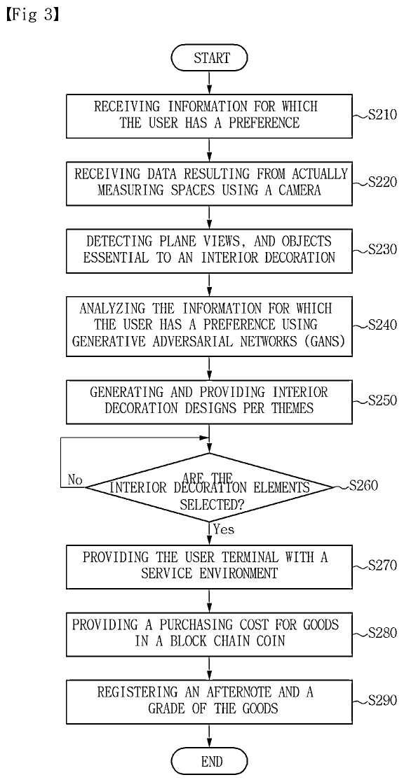

FIG. 1 presents a view for explaining the system of recommending interior decoration using GANs according to one of the possible realizations of the invention, and FIG. 2 shows a block diagram of the device used for offering recommendation on interior decoration with the help of GANS according to another possible realization of the invention. Hereinafter, the system and deice of offering recommendation on interior decoration using GANS are described with reference to FIGS. 1 and 2.

The system of offering recommendation on interior decoration using GANs can comprise the user terminal 110, the interior decoration recommendation device 120, and a partner company server 130. The user can fill out the corresponding field concerning interior decoration, providing data to the interior decoration recommendation device 120 (a platform) via the user terminal 110, and receive a coin as compensation. The interior decoration recommendation device 120 can recommend an interior design by analyzing the data of the user preference and the space filmed with a ToF sensor-based camera embedded in the user terminal 110. The interior decoration recommendation device 120 can also analyze various data related to user preferences and share it with the partner company server 130. If the company decides to deal with the request, it receives a coin as remuneration.

Thus, a partner company can obtain data patterns which the user is interested in and the consumer trends to provide goods and services according to their tastes and secure direct deals with the user, such as order production via a smart factory.

Following the interaction between the user terminal 110, the interior decoration recommendation device 120, and the cooperative company server 130, a smart contract is applied to the corresponding dealing so that the interaction is realized in a clear and safe manner.

In FIG. 2, the interior decoration recommendation device 120 in another realization of the invention can comprise a data-receiving part 121, an interior decoration constitution part 122, a sale environment provision part 123, and a coin processing part 124.

The data-receiving part 121 receives user preferences and the data obtained after measuring the target space with the camera in the user terminal. The interior decoration constitution part 122 detects the plane views and objects essential to interior decoration from the data and analyzes user preferences with the help of GANs. Additionally, the interior decoration constitution part 122 generates interior decoration designs by themes to arrange each interior decoration element in the space and to provide the user with visualizations. More specifically, this part can search applied laws and ordinances by analyzing user preferences and offer sample designs as 2D drawings based on the search. The interior decoration constitution part 122 can render 3D visualizations of the space based on the 2D drawings and generate interior decoration designs by themes to arrange interior decoration elements in the space. At this time, the part can analyze user preferences with the help of GANs and arrange furniture based on the space designs to suit user preferences, providing the user with visualizations.

When interior decoration elements are selected in the user terminal, the sale environment provision part 123 provides the user terminal with a service environment in which a partner company server offers goods matching the selected interior decoration elements. The coin processing part 124 provides the user terminal with a blockchain coin when receiving user requirements in the user terminal. The coin processing part 124 also provides the partner company server with the user requirements to obtain the blockchain coin from this server.

Meanwhile, GANs, as conditional generative adversarial networks (CGANs) in this invention, can be trained using a style dataset, where interior decoration designs are sorted by themes, and a location dataset, where interior decoration designs are sorted by location. The interior decoration constitution part 122 can analyze user preferences with the help of trained CGANs and generate interior decoration designs by themes to arrange each interior decoration element in the space and to provide the user with visualizations.

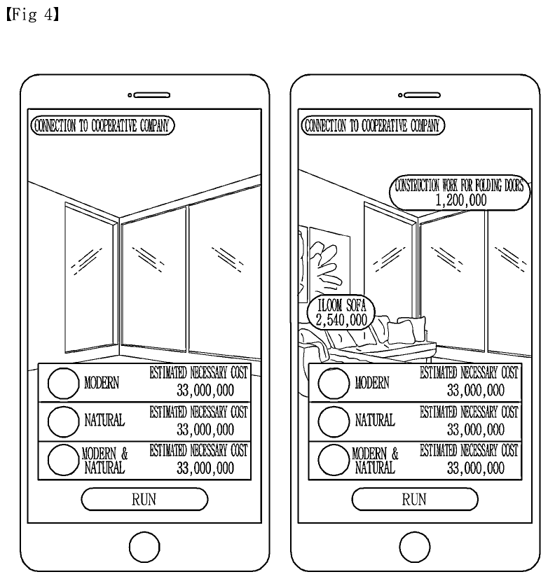

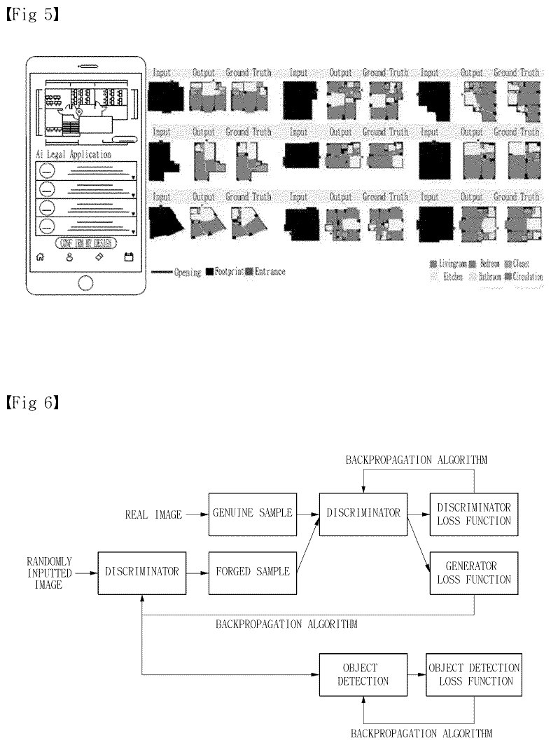

The flow chart shown in FIG. 3 explains the method of offering recommendation on interior decoration using GANs in one of the possible realizations of the invention. FIGS. 4 and 5 explain the interior decoration recommendation method using GANs in one of the possible realizations. Next, the method of offering recommendation on interior decoration using GANs is described with reference to FIGS. 3-5.

First, user preferences, or requirements, are received from the user terminal S210. At this time, the basic criteria of preferences are obtained using a questionnaire that the user fills out at the time of registration. When the interior decoration recommendation device receives user preferences from the user terminal, a block chain coin can be provided to the user terminal. The data resulting from measuring spaces with a camera are received from the user terminal S220, and the plane views and objects essential to interior decoration elements are detected from the data S230. At this time, the user can execute a service via the user terminal and obtain the data by measuring the space using the user terminal camera with a built-in ToF sensor to generate plane views and detect the objects essential to the previously arranged interior decoration. Next, the user preferences are analyzed with the help of GANs S240, and interior decoration designs are generated by themes to arrange each element in the space. The data are then provided to the user terminal S250. After that, interior decoration styles can be matched using GAN-based recommendation models, and a questionnaire to design the target space and arrange furniture can be carried out in the user's desired style. Alternatively, suitable interior decoration elements can also be arranged and visualized within the current styles of the space.

Thus, to design required spaces and furniture arrangement or visualize and provide interior decoration elements for the existing spaces, user preferences are analyzed using GANs to search for applied laws and ordinances and generate sample 2D and 3D visualizations featuring interior decoration designs by themes.

When the target space is completely remodeled based on user preferences, many laws and ordinances, such as the Building Act, the Fire Services Act, and district unit plans, must be studied. As illustrated in FIG. 5, prior to remodeling, the minimum data required for a legal inquiry, such as the type of business and space use, are first inputted, and then a search for applied laws and ordinances is carried out using artificial intelligence. The designed 2D visualizations are derived using architecture-generative adversarial networks (ArchiGANs) based on the results of the search. After that, the interior decoration recommendation device provides a partner company server with user requirements and obtains a blockchain coin from it. After the thematic interior decoration designs are generated and provided, and the interior decoration elements are selected in the user terminal S260, a partner company server can provide the user terminal with a service environment, offering goods that match the interior decoration elements S270. Finally, the user terminal provides the partner company server with the cost of the goods in blockchain coins S280. An afternote and the grade of the goods are registered with the partner company server via the user terminal, using a dispersion-type published ledger S290. The 3D models are visualized based on the obtained plane views. After customizing, an estimate can be calculated automatically, and an order for materials required for the construction work can be placed at a smart factory by contacting a partner company server.

According to another possible realization of the invention, this interior decoration recommendation method can include training GANs. In another variant, CGANs can be used and trained based on a style dataset, where interior decoration designs are sorted by theme, and a location dataset, where interior decoration designs are sorted by location. Next, the GANs used in the invention are described.

In FIG. 6, the GAN enables unsupervised learning, which generates a distribution by measuring probability based on the original data. As two neural networks of a generator and a discriminator compete with each other hostilely, and it is possible to synthesize high-quality photographs showing imitations closely resembling originals, GANs have been used in photography and videos. As a result, various models of improved performance and high utilization, such as WGAN, Cycle GAN, Star GAN, and DiscoGAN, have appeared.

A CGAN is a model intended to generate an image that meets a condition from an existing GAN (FIG. 7). If the general GAN cannot control the output by putting only noise in the condition of the input, the CGAN controls the output by adding specific conditions (vector y), such as, for example, a style.

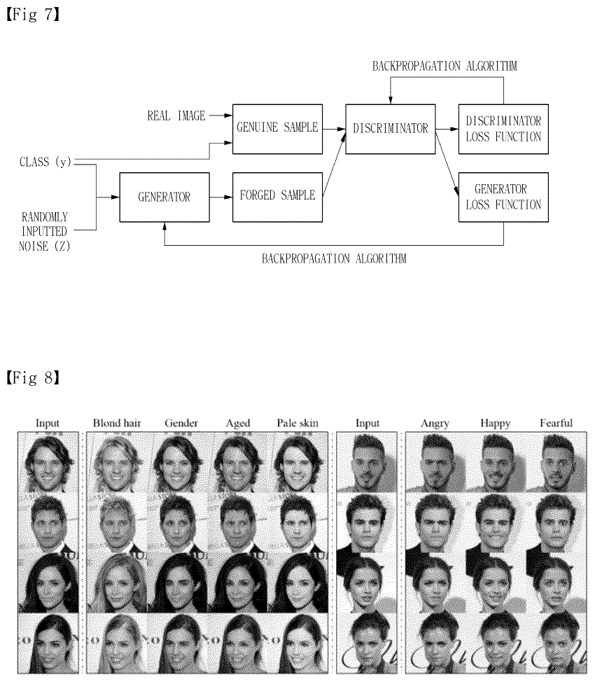

The StarGAN is a model that converts an image from one model into various styles of images (FIGS. 8 and 9). For example, it is possible to use one StarGAN to create images of various styles from an image of a person, changing, for example, the person's gender, age, or color of hair.

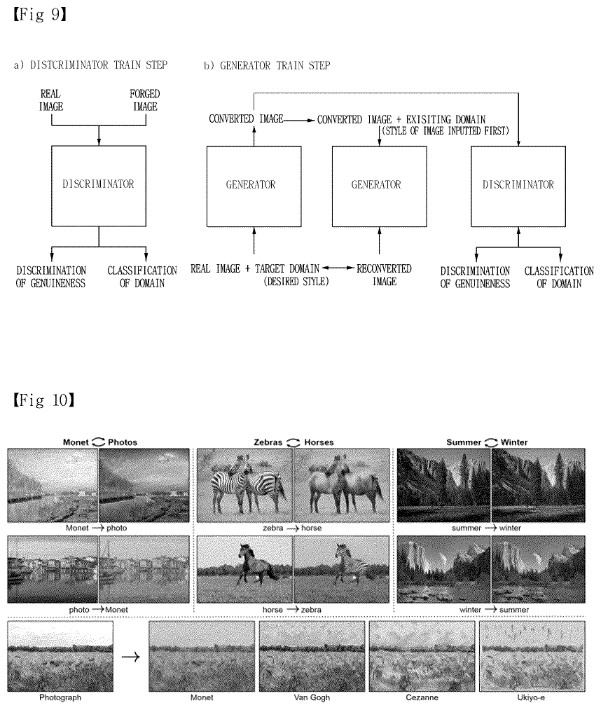

The CycleGAN is developed to match and combine a pix2pix-based neural network with the GAN (FIG. 10). For example, it is possible to convert an image of day into an image of night or an image of Monet's brushwork into an image of Van Gogh's brushwork. The CycleGAN shows that there are two pairs of generators and discriminators, which are used to convert image A into image B or image B into image A (FIG. 11). The discriminators identify the genuineness of the images in Domain A and Domain B, and a deep fake for synthesizing an image from the face of an unrelated person into a realistic image can be produced as the result of the practical application of the CycleGAN.

To improve the performance of neural networks based on the GAN, it is necessary to look for various model structures to find the optimal result by carrying out hyperparameter experiments. The variables that are changeable based on the optimization of GAN-based models are layer structures and neural network activation functions. The layer structure enables originals and imitations to be discerned through the number of TransConv2D+ReLU layers of the generators, the number of Conv2D+LeakyReLU layers of the discriminators, and the number of fully connected layers. It enables the manipulation of the number of strides, the number of channels of layers, etc.

In general, the more complicated a model becomes, the clearer the obtained image is, but as the number of calculations increases and the training process becomes more unstable, failure, such as mode collapse, can occur. To prevent this from happening, it is important to maintain the structural balance of generators and discriminators.

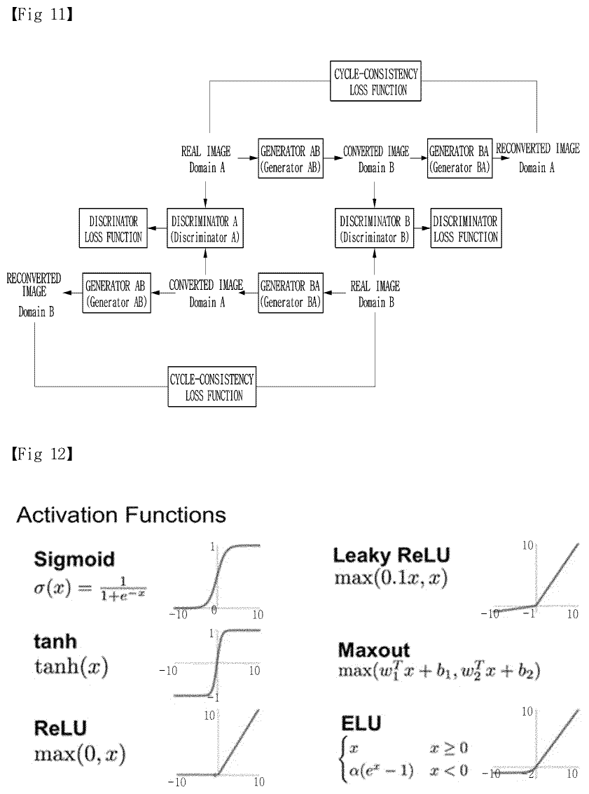

The neural network activation function allows us to determine whether to output the value inputted in the previous layer in the next layer (FIG. 12). A sigmoid activation function, an activation function based on tanh, etc., can be used in the activation function before the result is obtained.

The learning rate is the rate at which the value is adjusted to find the optimized point. If the learning rate is excessively large, the problem of overshooting, which shows slipping out of the minimum point, occurs. However, if the learning rate is too small, it is disadvantageous in that the speed for finding the minimum point becomes low.

The batch size represents the size of the data per bundle at the time of dividing the training data into bundles. The data are inputted in small bundles to ensure efficient learning.

An epoch is the amount of training data passing through neural networks; when the number is too large, it results in overfitting.

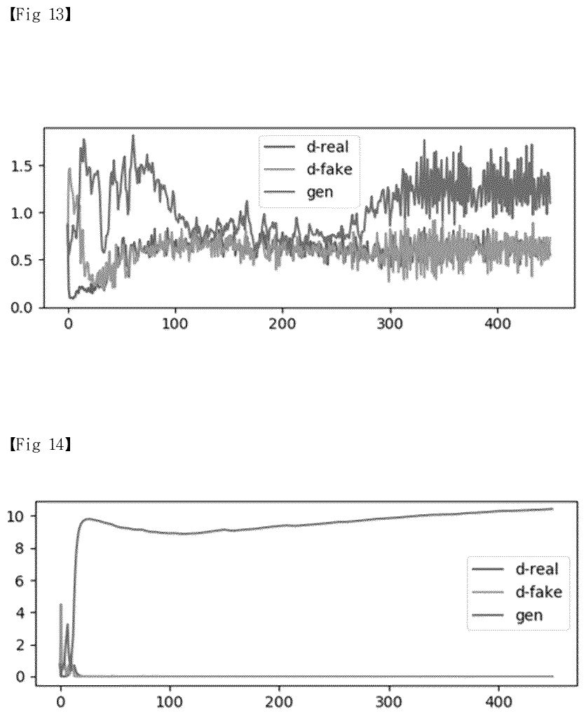

In addition, whether training is carried out smoothly can be monitored through changes in the loss functions of discriminators and generators. Ideally, if the values of the loss functions of generators and discriminators are similar and stable, the training of GANs can be regarded as being carried out smoothly. FIGS. 13 and 14 illustrate loss functions of ideal training and loss functions of training showing failure to convergence, respectively.

Next, the training method and the results related to the method of offering recommendation on interior decoration using GANs in one of the possible realizations of the invention are described.

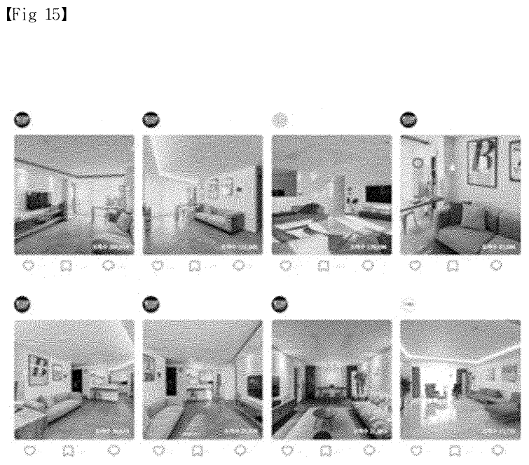

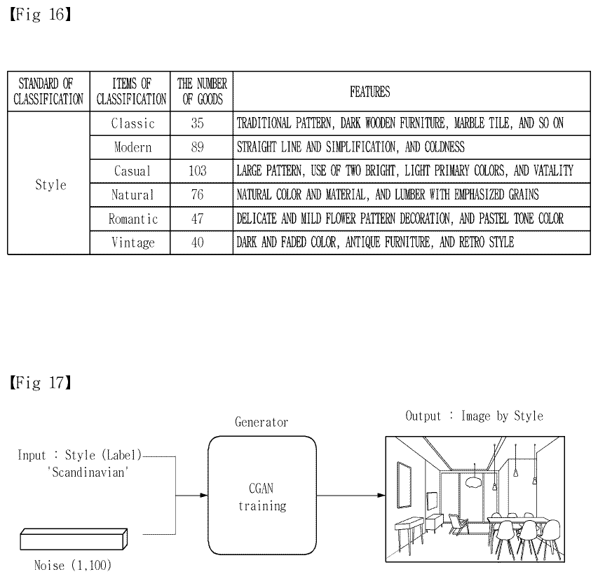

Images can be extracted from web pages, and an image dataset can be constructed by crawling from various sites (FIG. 15). When the data are collected, a Python library (Beautiful Soup) is utilized to extract images from web pages. Crawling is attempted through the IKEA interior decoration dataset of Github and the Today's House (https://ohou.se/) website; the goal is to construct a dataset of 390 images per six styles. Tags are created by matching the images of the dataset with suitable styles (FIG. 16). Furthermore, as shown in FIG. 17, when a condition value concerning, for example, a style is inputted through CGANs, a generator creates a suitable image, and a discriminator determines the genuineness of the image and whether the image corresponds to the style.

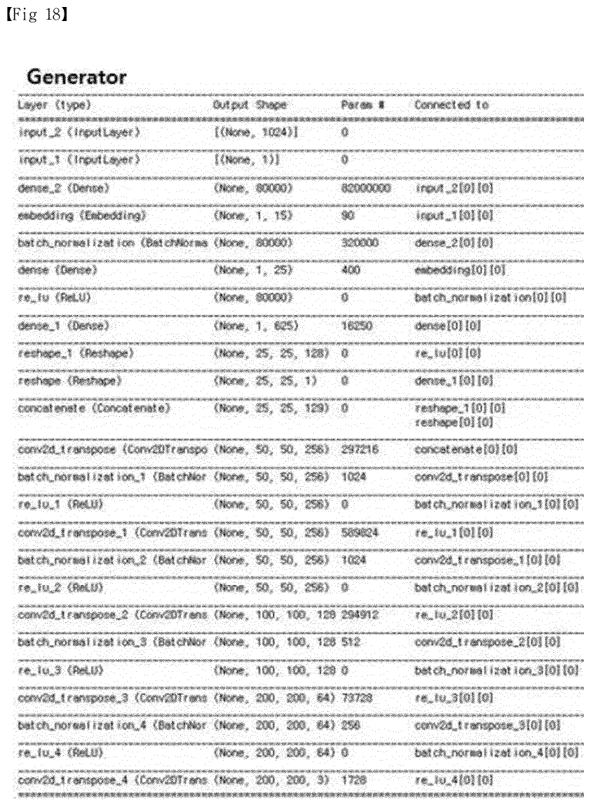

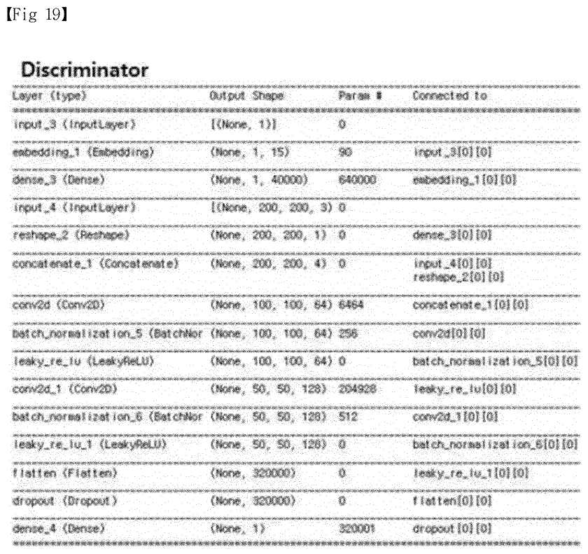

FIGS. 18 and 19 show the results of training related to the method of offering recommendation on interior decoration using the GANs according to another possible realization of the invention, where FIG. 18 represents model structures, and FIG. 19 represents hyperparameters.

According to one of the possible realizations of the invention, the constitution of the generator is formed more closely than that of the discriminator. Gradient vanishing is minimized by batch normalization; the batch size is 30; a total of 8,000 repetitive learning cycles are carried out. The learning rate is 0.0005, and the size of the final image is fixed to be 200 wide×200 high. The model structures and parameter values that use a mean squared error and enable stable training are applied to loss functions.

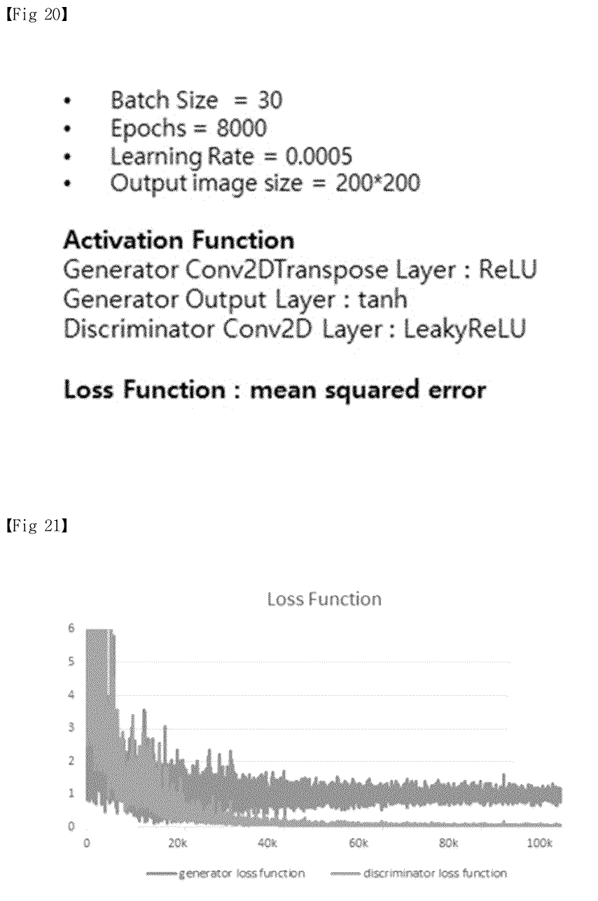

As reflected in FIGS. 20 and 21, it is found that the loss function of the discriminator gradually shows convergence in the range between 0.05 and 0.1, and the loss function of the generator gradually shows convergence in the range between 0.7 and 1.3. The loss function of the discriminator becomes 0, or the mode collapse, which makes the loss function of the generator vibrate, does not occur.

For example, CGANs can be trained using a style dataset, in which images have been sorted according to the decoration style, and a location dataset, in which images have been sorted according to location (e.g., a living room or bathroom). In the style dataset, a total of 6,280 images [bilateral symmetry]) were trained, and in the (3,140*2 location dataset, a total of 11,260 images (5,630*2 [bilateral symmetry]) were trained.

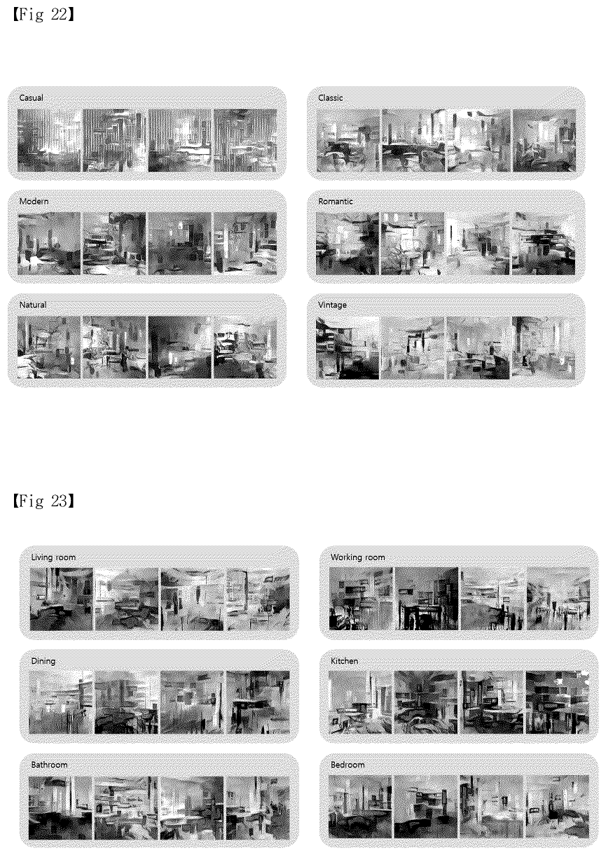

FIGS. 22 and 23 show that there are special features peculiar for each interior decoration style (e.g., color) and detailed arrangement of furniture (e.g., position of the ceiling and the floor). Therefore, differences in colors, atmosphere, etc. can be detected based on image generation models according to each style, and features peculiar to a location (e.g., desk or bed) can emerge from image generation models according to each location. If the quality of the dataset is enhanced, for example, by reversing the left to the right, it is possible to generate the most precise interior decoration design image compared to the other methods.

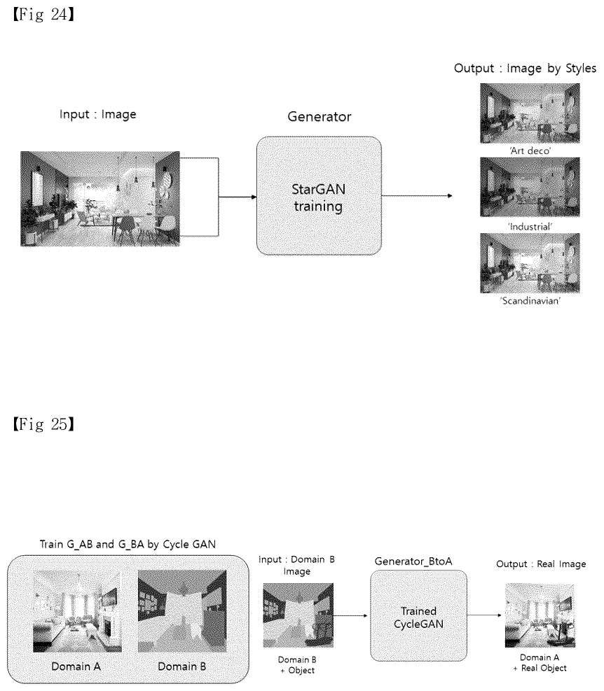

As shown in FIG. 24, when the user inputs a desired image using StarGANs, the image can be converted into images in various styles. The conversion of the image into images in various styles can be realized by one model.

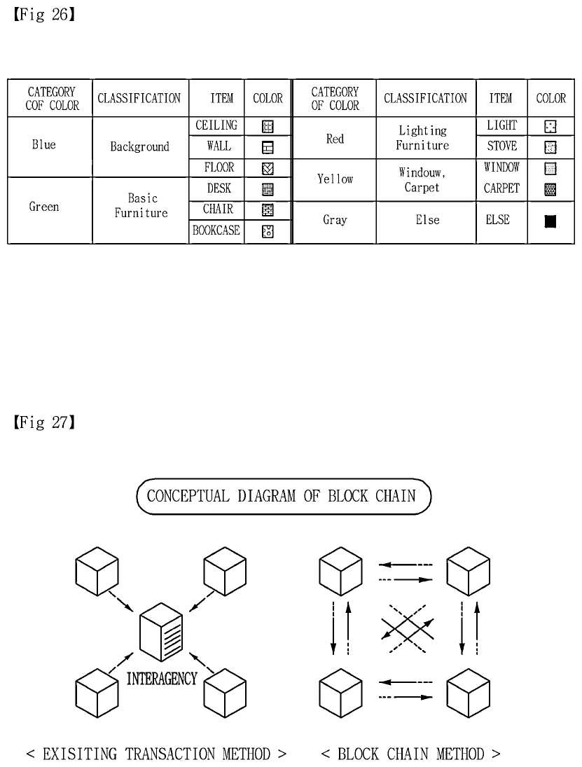

When the user designates the desired furniture on an indoor image and draws a border using CycleGANs, the images showing a suitable arrangement of the furniture can be outputted. At this time, the conversion of the real interior decoration image into simplified images is realized by image-to-image translation (FIGS. 25 and 26).

The block chain used in the invention is depicted in FIG. 27. A blockchain signifies a dispersion-type data storage technology of clearly recording the details of dealings in a digital ledger and copying and saving them on several computers. A node in a block unit is connected to a different block, thus holding the data in common and ensuring clarity. All nodes which participate in the block can carry out verification based on dispersibility, determinacy, and clarity. Nodes belonging to blockchain networks are prevented from being voluntarily operated using architecture called the reliable algorithm under a mutual agreement. This algorithm maintains the non-defects and security of a decentralized system. The nodes of a decentralized blockchain are dispersed, so it is necessary to come to an agreement concerning the validity of the transactions. In other words, the algorithm under mutual agreement can be regarded as a plan for overcoming the Byzantine fault.

Among various kinds of algorithms, the equilibrium proof of work (EPOW) is an algorithm under a mutual agreement that considers “balance” with respect to mining of the proof of work and overcome can the existing problem of centralization in block chain mining, saving electric resources required for the calculation process. Although the algorithm is identical to an existing method of proof of work, it creates a node that completes mining once by constituting the algorithm of Lyra2Rev2 ASICresistent and is not able to mine a block for a fixed time. Therefore, the probability of other nodes' success in mining increases, and the chance to mine is fairly distributed. Additionally, unlike other chains, mining is dispersed, so the block chain is prevented from centralization; the character of the nodes which participate in mining becomes varied, and the number of nodes is reduced to minimize unnecessary waste of energy.

The smart contract used in the invention is a script embodied in the code. When the contract is agreed on, and a specific condition is satisfied, the smart contract functions as a unit which ensures the corresponding contract is accomplished. As there is no intermediary, this type of contract is effective in cutting down the intermediation fee and time and advantageous in that the processes of execution of the contract and verification are automatized, and the verification can be made by a large number of people.

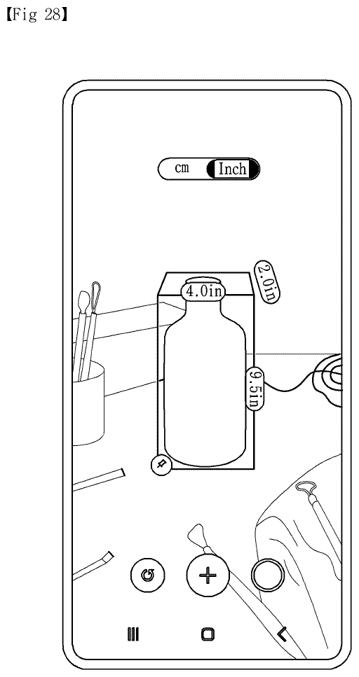

Also, the time-of-flight (ToF) sensor used in the proposed invention calculates distances by measuring the time required for a beam of light to be reflected and return after it is cast from a luminous source onto the object of shooting. Because the object of shooting is scanned by shooting infrared light (FIG. 28), it helps produce 3D scanning and a relatively accurate analysis of the object.

As mentioned previously, the detailed description of the invention presents descriptions of its possible realizations. However, various further modifications can be made with a deviation from the scope of the described invention. The technical idea of the invention should not be construed as being limited to the outlined possible realizations; rather, it should be determined based on the claims and their equivalents.

What is claimed:

1. A method of offering recommendation on interior decoration using GANS used in a device of offering recommendation on interior decoration comprises the following steps:
a) step one-receiving user preference information from the user terminal;
b) step two-receiving data resulting from measuring the target space using the user terminal camera;
c) step three detecting plane views and objects essential to the interior decoration from the data;
d) step four-analyzing user preferences using GANs and generating thematic interior decoration designs to arrange each interior decoration element in the space and provide the user with visualizations;
e) step five providing the user terminal with a service environment in which a partner company server offers goods matching the interior decoration elements selected in the user terminal.

2. The first step outlined in claim 1 can further involve providing the user terminal with a blockchain coin when the device of offering recommendation on interior decoration receives the user requirements from the user terminal.

3. The fourth step in the method of claim 1, where user preference information is analyzed using GANs, can include designing spaces, arranging furniture, and providing visualizations.

4. The fourth step in the method of claim 1, in which applied laws and ordnances are searched by analyzing user preference information with the help of GANs, generates sample 2D visualizations based on the result of the search and provide 3D models based on the 2D drawings, creating interior decoration designs by themes to arrange each interior decoration element in the space.

5. The fifth step in the method of claim 1, in which a blockchain coin is obtained from a partner company server after providing it with user preference information.

6. The fifth step in the method of claim 1, in which the user terminal provides a partner company server with the cost of the goods in a block chain coin, and the user terminal registers an afternote and the grade of the goods with the company server using a dispersion-type published ledger.

7. The method of claim 1 can further comprise a training step to train GANs before the first step.

8. The training step for the method of claim 7 involves a conditional generative adversarial network (CGAN), which is trained using a style dataset, in which the interior decoration designs are sorted by theme, and a location dataset, in which the interior decoration designs are sorted by location.

9. A device of offering recommendation on interior decoration using GANs comprises the following:
a) a data-receiving unit configured to receive user preference, or requirements, and the data resulting from measuring the space using the user terminal camera;
b) an interior decoration constitution unit configured to detect plane views and objects essential to the interior decoration from the data and to analyze user preference with the help of GANs to generate interior decoration designs by themes to arrange and provide the user with each decoration element in the space;
c) a sale environment provision unit configured to provide the user terminal with a service environment, in which a partner company server offers goods that match the interior decoration elements selected in the user terminal.

10. The device of claim 9 can further comprise a coin processing unit configured to provide the user terminal with a blockchain coin when user preference information is received from the user terminal.

11. The interior decoration constitution unit that is utilized in the device of claim 9 analyzes user preferences and then designs spaces, arranges furniture, and provides visualizations based on the requirements.

12. In the device of claim 9, the interior decoration constitution unit searches applied laws and ordnances by analyzing user preference with the help of GANS and subsequently derives sample 2D drawings, which are then rendered as 3D models. Thus, thematic interior decoration designs intended for arranging each interior decoration element in the space are generated, and the user is provided with corresponding visualizations.

13. As part of the device of claim 12, the coin processing unit receives a blockchain coin from a partner company server after providing it with user preference information.

14. In the device of claim 9, GAN is a CGAN that can be trained using a style dataset, in which the interior decoration designs are sorted by theme, and a location dataset, in which the interior decoration designs are sorted by location. The interior decoration constitution unit analyzes user preference information using trained CGANs and then generates thematic interior decoration designs intended for arranging each interior decoration element in the space and provides the user terminal with relevant images.

15. The recording medium, which the program uses to carry out the method of offering recommendation on interior decoration using GANs according to claim 1, is contained.
